(19) United States
(12) Patent Application Publication
(10) Pub. No.: US 2008/0126014 A1
(43) Pub. Date: May 29, 2008

(54) Statistical method and automated system for detection of particulate matter on wafer processing chucks

(76) Inventors: Yuanting Cui, Mechanicsville, VA (US); Rebecca Joyce-Woehrmann, Sandston, VA (US)

Correspondence Address: EDELL, SHAPIRO & FINNAN, LLC, 1901 RESEARCH BLVD., SUITE 400, ROCKVILLE, MD, 20850, US

(21) Appl. No.: 11/507,578

(22) Filed: Aug. 22, 2006

(51) Int. Cl. G01N 21/88; G06F 15/00

(52) U.S. Cl. 702/189; 356/237.4

(57) ABSTRACT

A method of detecting the presence of particulate matter on a wafer chuck during semiconductor wafer processing involves providing data which is related to a positional perturbation of a semiconductor wafer which is present during the processing of the wafer, providing a threshold which is based on historical statistics obtained from the prior processing of wafers, and comparing the data to the threshold to determine if a predetermined condition is violated, which corresponds to the presence of particulate matter on the chuck.

### FIELD OF THE INVENTION

The present invention is directed to the detection of particulate matter on wafer processing chucks, and particularly to a statistical method and automated system for accomplishing such detection in an efficient and timely manner.

### BACKGROUND OF THE INVENTION

In the manufacture of semiconductor devices, a wafer is typically exposed to radiation through a reticle or mask as part of a lithographic process. For the exposure to be accurate, the surface of the wafer or a photoresist layer thereon on which the radiation impinges must be in the focal plane of the optical system effecting the exposure.

However, if a particle becomes lodged between the chuck and the bottom of the wafer, a perturbation in the position of the wafer will result, and at least a part of the surface will not be in the correct focal plane. For example, such a particle may be a contaminant which unintentionally results from prior processing steps. A semiconductor device which is produced by such an exposure will typically contain a defect. The problem is compounded by the fact that the particle will tend to remain on the chuck, with the result that subsequent wafers will be similarly affected.

In the prior art, the most common detection scheme for particulate matter on the chuck was to inspect the finished semiconductor device, typically through a microscope. However, visual inspection is labor intensive, time consuming, with sparse sampling and significant delay from detection to correction. This results in a long manufacturing cycle time and the production of a relatively large number of defective products. Additionally, a previously tried in-line detection method used a simple wafer comparison and had a relatively low signal to noise ratio, i.e., false detection when there is no actual particle presents. The many false alarms which were generated resulted in excessive tool downtime, which is quite costly in a volume manufacturing environment.

### SUMMARY OF THE INVENTION

In accordance with the present invention a method of detecting the presence of particulate matter on a wafer chuck during semiconductor wafer processing is provided which comprises providing data which is related to a positional perturbation of a semiconductor wafer which is present during the processing of the wafer, providing a threshold which is based on historical statistics obtained from the prior processing of wafers, and comparing the data to the threshold to determine if a predetermined condition is violated, which corresponds to the presence of particulate matter on the chuck.

The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

FIG. 1 shows a lithographic exposure system where there is a particle lodged between the chuck and the wafer.

FIG. 2 is a block diagram of an embodiment of a particle detection system.

FIG. 3 is a flow chart which depicts an embodiment of the particle detection method of the invention.

FIG. 4 is a plot of data points of the across wafer standard deviation of ‘z-height Moving Average’ against threshold vs. time.

### DETAILED DESCRIPTION

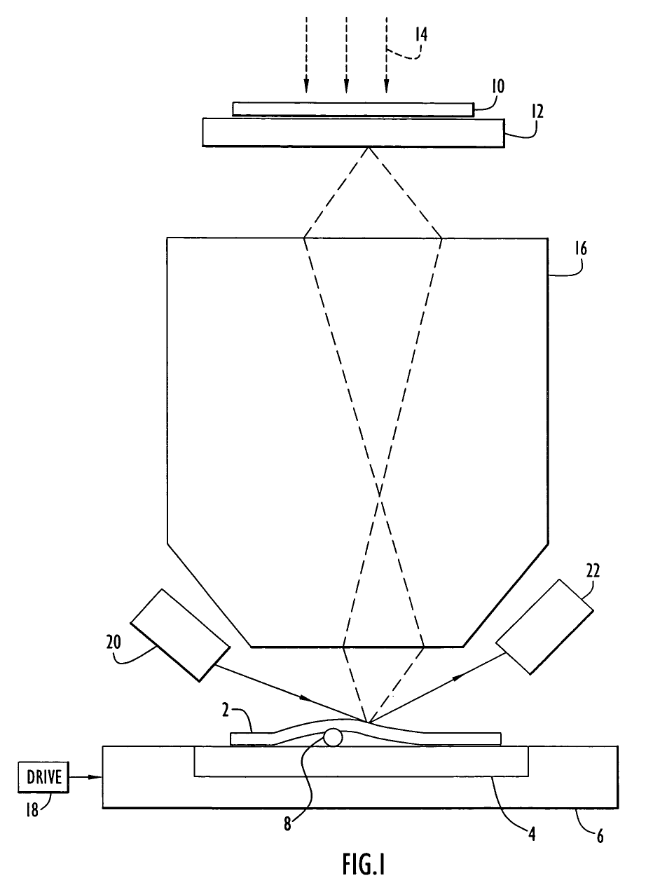

FIG. 1 shows a lithographic exposure system for exposing wafer 2. While ideally the wafer would lie flat on the chuck 4, as can be seen in FIG. 1 there is a particle 8 lodged between the chuck and the bottom of the wafer. The particle causes a perturbation in the height of the wafer which causes part of the wafer to be outside of the focal plane of the optical system. The particle is typically a contaminant resulting from a prior processing step.

It is desirable to discover such a problem as soon as possible, i.e., on an in-line real time basis, so that it may be corrected before it is repeated on subsequent wafers. Without correction, the particulate material is likely to remain on the chuck and cause repeat errors in consecutive wafers which are exposed.

Referring again to FIG. 1, examples of a photolithography system and wafer surface metrology system will be described. Reticle or mask 10 has a pattern formed therein which it is desired to transfer to photoresist which is disposed on the surface of wafer 2. Reticle 10 is mounted on reticle stage 12. A projection lens 16 focuses the reticle pattern onto the photoresist on the wafer surface.

Chuck 4 which supports the wafer 2 is set in moveable stage 6, which is driven in the x and y directions by drive 18. In the operation of a Step and Scan exposure system, reticle stage 12 and chuck stage 6 are moved in synchronism to effect successive scan of an exposure field. Each scan field consists of a certain number of die with the same pattern defined by the mask layout, and is repetitively exposed until the requisite number of dies cover the whole wafer.

The optical metrology system depicted is comprised of laser 20 and photodetector 22. Its purpose is to detect a perturbation in the height of the wafer, such as is shown in FIG. 1. The measurement laser beam is projected onto a specific location on the wafer surface, and is being reflected to the detection unit, where the z position of the wafer location is derived from the intensity profile of the light through the grating. This measurement data is then used by the motion controller to position the wafer in the focal plane.

From the raw data obtained by the metrology system relating to the height of the wafer, dynamic performance parameters may be derived. An approach to obtaining such parameters is to measure the perturbation across each scanning shot and compare this with the average perturbation resulting from scanning across the entire wafer. Dynamic performance parameters obtained in this way which are useful are the across wafer standard deviation of z-height moving average and the maximum z-height moving average, which will be discussed in further detail below.

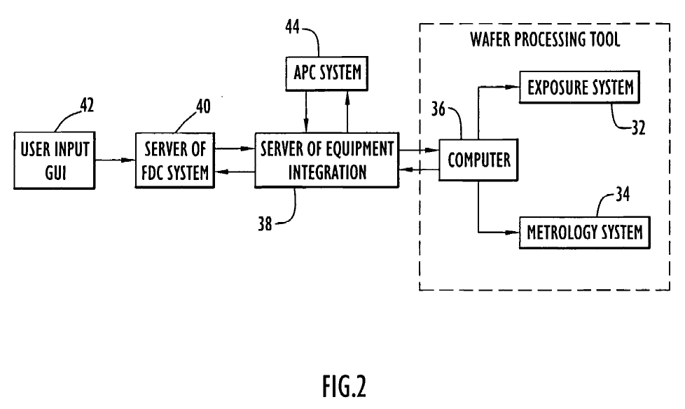

FIG. 2 is a block diagram of an embodiment of a system which may incorporate the invention. Exposure system 32 is used to perform a photolithography operation, while the purpose of wafer metrology system 34 is to measure a positional perturbation of the wafer. However, the invention is not limited to such embodiment, as it also encompasses detecting a particle under the wafer at other stages which involve stage movement in z direction during processing.

It is noted that the term “chuck” as used herein means any holder or platform for a wafer in or on which the wafer is situated during a processing operation.

Referring again to FIG. 2, computer 36 controls the operation of exposure system 32; specific parameters relevant to the job being performed may be downloaded from APC system 44 (Advanced Process Control) through equipment integration system 38. The output of wafer metrology system 34 is fed to the computer for further interpretation and meanwhile is sent through equipment integration system to FDC system 40 (Fault Detection Control), where data is stored and analyzed. Based on the requirement set by user input 42, FDC system may determine the continuation of the following wafer process and send the command to computer 36.

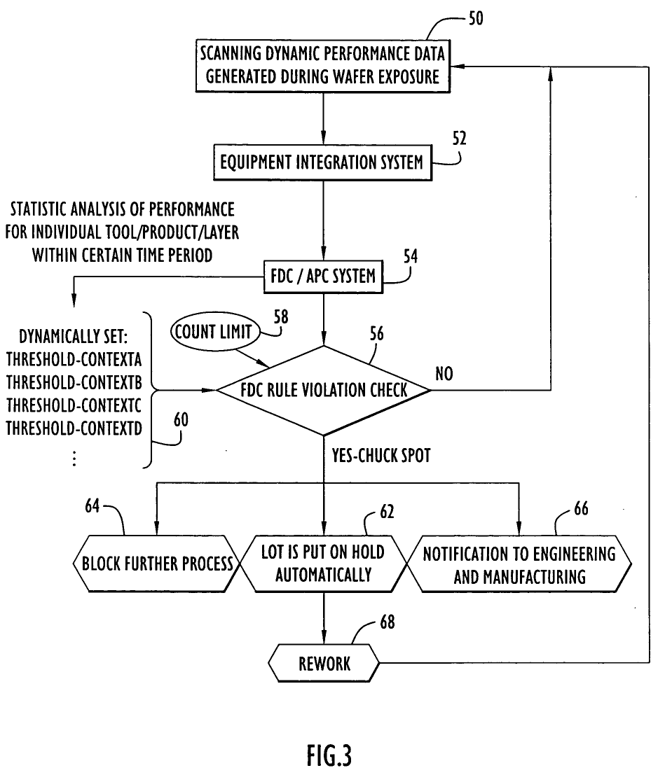

FIG. 3 is a flow chart of a method in accordance with an embodiment of the invention. FIG. 3 relates to an embodiment which is directed to the detection of particulate matter during a photolithographic exposure operation.

Referring to FIG. 3, method step 50 relates to providing dynamic performance parameter data which is generated by the scanning of the wafer. Referring to FIG. 1, raw scanning data is obtained by the metrology system including laser 20 and photodetector 22, combined with the scanning action of the step and scan exposure system previously described. From the raw data, computer 36 shown in FIG. 2 derives one or more dynamic performance parameters which are shown to have a strong correlation with localized topology change caused by particles being lodged under the wafer. Two such parameters which may be used are the across-wafer standard deviation of z-height Moving Average and the maximum z-height Moving Average. Moving Average (MA) is defined as the average error between the required position and the actual position over a given time interval, which is the scan during each exposure shot in this case. The standard deviation and the maximum value of the Moving Average of all exposed fields of a whole wafer are then reported.

Block 52 relates to an equipment integration system which transports the dynamic performance data after each wafer completion event from the exposure tool to the FDC/APC system 54 (Fault Detection Control/Automatic Process Control), which may be part of the manufacturing control system and where data generated for each wafer or lot during processing can be stored and calculated.

At step 56 the FDC rule violation check is performed. Reference numeral 60 refers to a threshold which is provided which is based on historical statistics obtained from the processing of prior wafers under conditions similar to those present for the wafer being processed. Three of several such conditions which may be used are the end product being made, the layer being worked on, and the particular exposure tool which is used. A number of thresholds may be available, since threshold is calculated and set separately for each individual context which is identified as Context A, Context B . . . Context n. Each context corresponds to a particular combination of conditions for example, a dynamic random access memory (DRAM) is the end product, the second layer is being worked on, and the particular exposure tool is Serial No. X1P3.

When the wafer is completed, a particular threshold is selected automatically by the FDC system based on which context the processed wafer belongs to, and the performance data of the specific wafer is compared against this threshold. Each threshold would be based on historical statistics for the particular combination of conditions and would be selected so that if a requisite number of data points exceed the threshold, a predetermined condition is violated, which corresponds to the presence of particulate matter under the wafer. Context-based threshold to be used for the following processed wafers is automatically re-calculated from the new statistics after each wafer's completion. Through the use of historical statistics, normal performance variations are effectively separated from the performance shift due to real particles on the chuck resulting in a relatively high signal to noise ratio.

The count limit is denoted at block 58, and if the output of decision step 56 is “No”, meaning that the count limit has not been exceeded, the wafer exposure process continues. On the other hand, if the count limit is exceeded, the output of decision step 56 is a “Yes” meaning that particulate matter has been detected, and prompt action is taken. Referring to FIG. 3, one or more of the actions denoted by steps 62, 64, 66, and 68 may be taken. That is, the exposure process is blocked (step 64), the lot may be automatically put on hold (step 62), and notification may be provided to the engineering and manufacturing department. Additionally, the wafer being processed may be reworked so as to ensure a product without defects. (Step 68) Because the corrective actions can be put in place immediately after detection of the problem, the re-working is reduced and the yield loss is minimized.

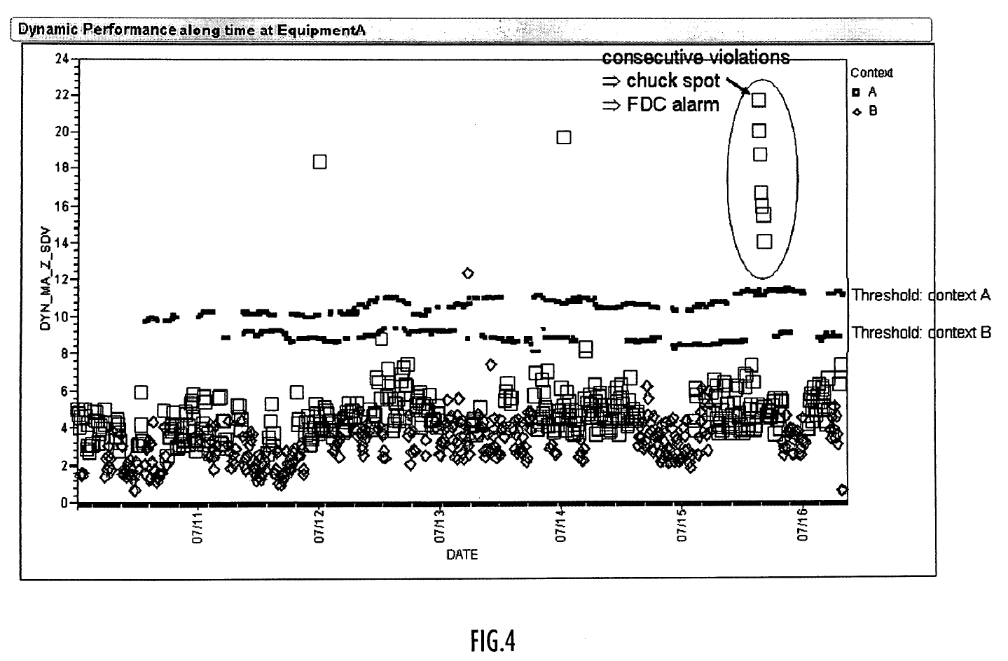

FIG. 4 is a plot of a dynamic performance data (across wafer standard deviation of z-height moving average) of wafers within two different contexts, Context A and Context B, as a function of date. Two thresholds, which are dynamically calculated based on historical statistics are depicted as well. As can be clearly seen, at the date of July 15, several consecutive data points for Context A clearly exceed the threshold. In this case the relevant predetermined condition has been violated, which denotes the presence of a particulate matter under the wafer.

Thus, methodology and systems for detecting the presence of particulate matter on a wafer chuck have been disclosed. The invention may be used in the fabrication of many different types of semiconductor products, including dynamic access random access memories (DRAMs). Also, while the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

1. A method of detecting the presence of particulate matter on a wafer chuck during semiconductor wafer processing, comprising:
providing data which is related to a positional perturbation of a semiconductor wafer which is present during the processing of the wafer;
providing a threshold which is based on historical statistics obtained from the prior processing of wafers; and
comparing said data to said threshold to determine if a predetermined condition is violated, which corresponds to the presence of particulate matter on the wafer chuck.

2. The method of claim 1 wherein the historical statistics on which the threshold is based are obtained from the prior processing of wafers under wafer processing conditions similar to those under which the wafer is being processed.

3. The method of claim 2 wherein the wafer processing conditions include one or more of the type of end product resulting from the processing, a layer being worked on, and an exposure tool which is used.

4. The method of claim 3 wherein comparing said data to said threshold to determine if a predetermined condition is violated includes counting data points.

5. The method of claim 1 wherein the data provided which is related to a positional perturbation of a semiconductor wafer is related to a perturbation in the height of the wafer.

6. (canceled)

7. The method of claim 27 wherein said lithographic exposure of the wafer comprises optically scanning the wafer to provide information, and wherein said data which is provided comprises a dynamic performance parameter which is derived from said information.

8. The method of claim 7 wherein said scanning includes a scanning shot, and wherein the dynamic performance parameter is based on a comparison of information obtained from scanning shot with information obtained from scanning across the entire wafer.

9. The method of claim 7 wherein the dynamic performance parameter is a standard deviation of z-height moving average.

10. The method of claim 7 wherein the dynamic performance parameter is a maximum z-height moving average.

11-15. (canceled)

16. A system for detecting the presence of particulate matter on a wafer chuck during semiconductor wafer processing, comprising:
means for providing data which is related to a positional perturbation of a semiconductor wafer which is present during the processing of the wafer;
means for providing a threshold which is based on historical statistics obtained from the prior processing of wafers; and
means for comparing said data to said threshold to determine if a predetermined condition is violated, which corresponds to the presence of particulate matter on the chuck.

17. The system of claim 16 wherein the means for providing a threshold provides a threshold which is based on historical statistics obtained from the prior processing of wafers under wafer processing conditions similar to those under which the wafer is being processed.

18. The system of claim 17 wherein the wafer processing conditions include one or more of: a type of the end product resulting from the processing, a layer being worked on, and an exposure tool which is used.

19. The system of claim 18 wherein said means for comparing said data to said threshold comprises means for counting data points.

20. The system of claim 16 wherein the means for providing data provides data which is related to a positional perturbation in the height of the wafer.

21. A storage medium containing a set of instructions which can be implemented by a computer for performing method steps for detecting the presence of particulate matter on a wafer chuck during semiconductor wafer processing, said method steps comprising:
providing data which is related to a positional perturbation of a semiconductor wafer during the processing of the wafer;
providing a threshold which is based on historical statistics obtained from the prior processing of wafers; and
comparing said data to said threshold to determine if a predetermined condition is violated, which corresponds to the presence of particulate matter on the chuck.

22. The storage medium of claim 21 wherein the historical statistics on which the threshold is based are obtained from the prior processing of wafers under wafer processing conditions similar to those under which the wafer is being processed.

23. The storage medium of claim 22 wherein the wafer processing conditions include one or more of: a type of the end product resulting from the processing, a layer being worked on, and an exposure tool which is used.

24. The storage medium of claim 23 wherein comparing said data to said threshold to determine if a predetermined condition is violated includes counting data points.

25. The storage medium of claim 21 wherein the data provided which is related to a positional perturbation of a semiconductor wafer is related to a perturbation in the height of the wafer.

26. The method of claim 5 wherein said semiconductor wafer processing is lithographic exposure of the semiconductor wafer.

27. The method of claim 26 wherein the threshold provided is based on historical statistics obtained from the prior processing of wafers under conditions similar to those under which the wafer is being processed, which conditions include at least one of: a type of product being made, a layer being worked on, and an exposure tool which is used.
